(19) United States
(12) Patent Application Publication
(10) Pub. No.: US 2025/0212192 A1
(43) Pub. Date: Jun. 26, 2025

(54) RESOURCE CONFIGURATION METHOD AND APPARATUS

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/852,013

(22) PCT Filed: Mar. 28, 2022
(86) PCT No.: PCT/CN2022/083458

§ 371 Date: Sep. 27, 2024

(51) Int. Cl. H04W 72/0453; H04W 16/28; H04W 72/51; H04W 72/541

(52) U.S. Cl. CPC H04W 72/0453; H04W 16/28; H04W 72/51; H04W 72/541

(57) ABSTRACT

A resource configuration method, performed by a network device in a target cell, includes: sending frequency domain configuration information to a network device in a neighbor cell of the target cell, where the frequency domain configuration information indicates at least one of first uplink frequency domain resources or first downlink frequency domain resources of the target cell, or indicates at least one of second uplink frequency domain resources or second downlink frequency domain resources to be configured for the neighbor cell.

### CROSS-REFERENCE TO RELATED APPLICATION

This application is the U.S. national phase application of International Application No. PCT/CN2022/083458, filed on Mar. 28, 2022, the disclosure of which is incorporated herein by reference in its entirety for all purposes.

### TECHNICAL FIELD

The present disclosure relates to the field of communication technologies, and in particular to a resource configuration method and an apparatus thereof.

### BACKGROUND

Duplex mode enhancement is an important part being studied in Release 18 (Rel-18) of 3rd generation partnership project (3GPP), with a focus on performing data transmission and data reception simultaneously in one slot. If the data transmission and the data reception are implemented simultaneously over one carrier, a transmitting end and a receiving end need to be able to suppress a cross-slot interference and a self-interference well. For the cross-slot interference, it may be measured, avoided and eliminated by certain mechanisms. For the self-interference, the transmitting end and the receiving end need to have a high transmit-receive isolation to achieve a strong self-interference suppression capability.

In related arts, in order to minimize an impact on complexity and radio frequency aspects of a terminal device, the research on the duplex mode enhancement may be limited to a network device side, that is, full-duplex is supported only on the network device side. A cross interference between different cells may be avoided by exchanging an intended downlink (DL)/uplink (UL) slot format between the network devices.

However, by merely exchanging time domain information, it cannot satisfy a usage requirement of a scenario where a flexible duplex is supported.

### SUMMARY

An example of a first aspect of the present disclosure provides a resource configuration method, performed by a network device in a target cell, and the method including: sending frequency domain configuration information to a network device in a neighbor cell of the target cell, wherein the frequency domain configuration information indicates uplink frequency domain resources and/or downlink frequency domain resources of the target cell, or indicates uplink frequency domain resources and/or downlink frequency domain resources to be configured for the neighbor cell.

In this technical solution, the frequency domain configuration information is sent by the network device in the target cell to the network device in the neighbor cell of the target cell (hereinafter referred to as a neighbor cell network device). The frequency domain configuration information indicates the uplink frequency domain resources and/or the downlink frequency domain resources of the target cell, or indicates the uplink frequency domain resources and/or the downlink frequency domain resources to be configured for the neighbor cell. Therefore, after receiving the frequency domain configuration information, the neighbor cell network device can configure the uplink frequency domain resources and/or the downlink frequency domain resources for the neighbor cell according to the frequency domain configuration information to avoid a cross interference, thereby improving a transmission performance. That is, by exchanging the frequency domain information between the network devices, the cross interference between different cells can be avoided, which can not only improve the transmission performance, but also improve a flexibility and an adaptability of the method, thereby meeting actual application demand.

An example of a second aspect of the present disclosure provides another resource configuration method, performed by a network device in a neighbor cell of a target cell, and the method including: receiving frequency domain configuration information sent by a network device in the target cell; and configuring uplink frequency domain resources and/or downlink frequency domain resources for the neighbor cell according to the frequency domain configuration information.

An example of a third aspect of the present disclosure provides a communication device including one or more processors. The one or more processors, when calling a computer program in one or more memories, are configured to: send frequency domain configuration information to a network device in a neighbor cell of the target cell, wherein the frequency domain configuration information indicates uplink frequency domain resources and/or downlink frequency domain resources of the target cell, or indicates uplink frequency domain resources and/or downlink frequency domain resources to be configured for the neighbor cell.

### BRIEF DESCRIPTION OF THE DRAWINGS

In order to explain the technical solution in examples of the disclosure or in the background more clearly, the following will describe the accompanying drawings that need to be used in the examples or in the background.

FIG. 1 is a schematic structural diagram of a communication system provided in an example of the present disclosure.

FIG. 2 is a schematic diagram of interference between devices.

FIG. 3 is a schematic flowchart of a resource configuration method provided in an example of the present disclosure.

FIG. 4 is a schematic flowchart of another resource configuration method provided in an example of the present disclosure.

FIG. 5 is a schematic flowchart of another resource configuration method provided in an example of the present disclosure.

FIG. 6 is a schematic flowchart of another resource configuration method provided in an example of the present disclosure.

FIG. 7 is a schematic flowchart of another resource configuration method provided in an example of the present disclosure.

FIG. 8 is a schematic flowchart of another resource configuration method provided in an example of the present disclosure.

FIG. 9 is a schematic structural diagram of a resource configuration apparatus provided in an example of the present disclosure.

FIG. 10 is a schematic structural diagram of a communication device provided in an example of the present disclosure.

FIG. 11 is a schematic structural diagram of a chip provided in an example of the present disclosure.

### DETAILED DESCRIPTION OF THE EMBODIMENTS

In order to better understand a resource configuration method disclosed in an example of the present disclosure, the following is first to describe a communication system to which the examples of the present disclosure are applicable.

In order to make the purpose, technical solutions and advantages of the present disclosure clearer, the following is further to describe in detail the implementations of the present disclosure in conjunction with the accompanying drawings.

Examples will be described in detail herein, whose instances are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

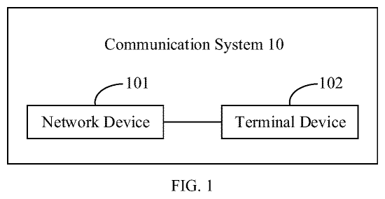

With reference to FIG. 1, it is a schematic structural diagram of a communication system 10 provided in an example of the present disclosure. The communication system may include but not limited to a network device and a terminal device. The number and the form of the devices illustrated in FIG. 1 are for only an example purpose and do not constitute a limitation on the example of the present disclosure. In practical applications, it may include two or more network devices and two or more terminal devices. It is an example that the communication system 10 illustrated in FIG. 1 only includes one network device 101 and one terminal device 102.

It is to be noted that the technical solutions of the examples of the present disclosure may be applied to various communication systems, for example, a long term evolution (LTE) system, a 5th generation (5G) mobile communication system, a 5G new radio (NR) system or another new mobile communication system in future, etc.

The network device 101 in the example of the present disclosure is an entity on a network side for transmitting or receiving signals. For example, the network device 101 may be an evolved NodeB (eNB), a transmission reception point or transmit receive point (TRP), a next generation NodeB (gNB) in an NR system, a base station in the another new mobile communication system in future, or an access point in a wireless fidelity (WiFi) system, etc. The example of the present disclosure has no limits for the specific technology and the specific device form of the network device. The network device provided by the example of the present disclosure may be composed of a central unit (CU) and one or more distributed units (DUs). The CU may also be called a control unit. The use of the CU-DU architecture allows for splitting a protocol layer of the network device such as the base station, with part of functions of a protocol layer placed in the CU for a central control, and part or all of the remaining functions of the protocol layer distributed in the DUs that are controlled centrally by the CU.

The terminal device 102 in the example of the present disclosure is an entity on a user side for receiving or transmitting signals, for example, a mobile phone. The terminal device may be also referred to as a terminal, user equipment (UE), a mobile station (MS), a mobile terminal, etc. The terminal device may be a car equipped with a communication function, a smart car, a mobile phone, a wearable device, a pad, a computer with a wireless transmission and reception function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, and a wireless terminal devices in a smart city, a wireless terminal device in smart home, etc. The example of the present disclosure has no limits for the specific technology and the specific device form of the terminal device.

In the described communication system, a full-duplex enhancement is only for the network device, while the terminal device still only supports half-duplex. That is because a transmitting end and a receiving end need to be able to suppress a cross-slot interference and a self-interference well if data transmission and data reception are implemented simultaneously over one carrier. For the cross-slot interference, it may be measured, avoided and eliminated by certain mechanisms. For the self-interference, the transmitting end and the receiving end need to have a high transmit-receive isolation to achieve a strong self-interference suppression capability.

Generally, the full-duplex may improve a throughput, reduce a transmission delay, especially reduce the transmission delay of uplink transmissions, and enhance an uplink coverage. However, in order to achieve the above purposes, it is necessary to schedule the uplink transmissions in a downlink (DL) time domain range (region) of a time division duplex (TDD) frequency band or a DL frequency domain range (spectrum) of a frequency division duplex (FDD) frequency band. According to the existing protocols, the terminal device cannot transmit uplink data in a DL slot.

Duplex mode enhancement is an important part being studied in Release 18 (Rel-18) of 3rd generation partnership project (3GPP), with a focus on performing the data transmission and the data reception simultaneously in one slot. If the data transmission and the data reception are implemented simultaneously over one carrier, the transmitting end and the receiving end need to be able to suppress the cross-slot interference and the self-interference well.

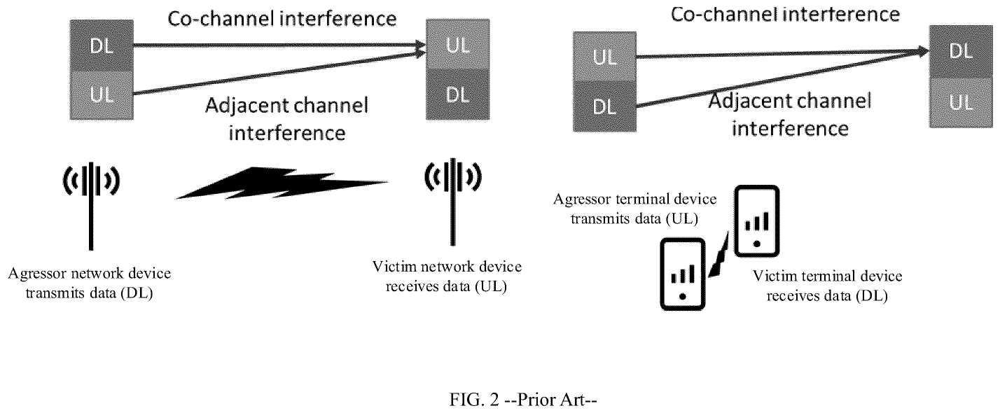

As an example, and as illustrated in FIG. 2, interferences may include a co-channel interference and an adjacent channel interference when data is transmitted between network devices or when data is transmitted between terminal devices.

In view of this, in order to minimize an impact on complexity and radio frequency (RF) aspects of the terminal device, there is a prevailing consensus that the studies on the duplex mode enhancement are limited to the network device side, that is, the full-duplex is only supported on the network device side.

The full-duplex solutions on the network device side mainly include three types as follows.

The first type is Non-overlapping subband. That is, the uplink data and the downlink data are transmitted on different subbands, and there are no overlaps between the subbands in the frequency domain.

The second type is Partial-overlapping subband. That is, the uplink data and the downlink data are transmitted on different subbands, and there is partial overlap between the subbands in the frequency domain.

The third type is Shared-spectrum full duplex. That is, the uplink data and the downlink data may be transmitted on completely overlapped frequency domain resources.

In previous studies, avoiding a cross interference between different cells may be done by exchanging an intended DL/uplink (UL) slot format between the network devices. However, it cannot meet the usage requirements of supporting flexible duplex by merely exchanging time domain information.

In view of these problems, the present disclosure provides the resource configuration methods and apparatuses.

It is to be understood that the communication system described in the example of the present disclosure is intended to illustrate the technical solutions of the examples of the present disclosure more clearly, but do not constitute any limitation to the technical solutions provided in the examples of the present disclosure. Those of ordinary skill in the art will know that the technical solutions provided in the examples of the present disclosure are also applicable to similar technical problems which occur with the system architecture evolving and new business scenarios emerging.

The following describes in detail the resource configuration methods and apparatuses provided in the present disclosure in conjunction with the accompanying drawings.

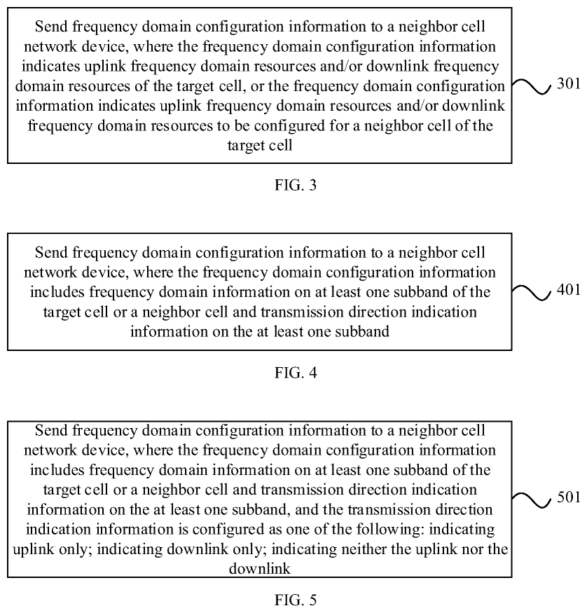

With reference to FIG. 3, it is a schematic flowchart of a resource configuration method provided in an example of the present disclosure. The resource configuration method may be performed by the network device in the communication system illustrated in FIG. 1. For example, it may be performed by the network device in a target cell. The target cell may be any serving cell.

As illustrated in FIG. 3, the resource configuration method may include, but is not limited to, the following step 301.

At step 301, frequency domain configuration information is sent to a neighbor cell network device, where the frequency domain configuration information indicates uplink frequency domain resources and/or downlink frequency domain resources of the target cell, or the frequency domain configuration information indicates uplink frequency domain resources and/or downlink frequency domain resources to be configured for a neighbor cell of the target cell.

In the example of the present disclosure, the neighbor cell network device may be a network device in the neighbor cell of the target cell.

In the example of the present disclosure, the network device in the target cell may send the frequency domain configuration information to the neighbor cell network device. Thus, after receiving the frequency domain configuration information, the neighbor cell network device may configure the uplink frequency domain resources and/or downlink frequency domain resources for its corresponding serving cell (i.e., the neighbor cell of the target cell) according to the frequency domain configuration information to avoid the cross interference, thereby improving the transmission performance. Therefore, a cross interference between different cells can be avoided by exchanging the frequency domain information between the network devices, which can improve the adaptability of the method, thereby meeting actual application demand.

As an example showing that the frequency domain configuration information indicates the uplink frequency domain resources and/or the downlink frequency domain resources of the target cell, after determining the uplink frequency domain resources and/or the downlink frequency domain resources of the target cell, the network device in the target cell may generate the frequency domain configuration information based on the uplink frequency domain resources and/or the downlink frequency domain resources of the target cell, and send the frequency domain configuration information to the neighbor cell network device. Accordingly, after receiving the frequency domain configuration information, the neighbor cell network device may determine a reference terminal device (or called a target terminal device) in the neighbor cell (i.e., the cell corresponding to the neighbor cell network device). The reference terminal device is a terminal device located at the edges of the neighbor cell and the target cell. That is, the reference terminal device may be located in an overlapping area between the target cell and the neighbor cell. Thus, the neighbor cell network device may configure the frequency domain resources of the neighbor cell used by the reference terminal device according to the received frequency domain configuration information. For example, according to the received frequency domain configuration information, it may configure subband configuration information (e.g., frequency range information of a working carrier to which a subband belongs, a bandwidth of the subband, a number of subbands included in the working carrier to which the subband belongs, etc.) for the reference terminal device. The subband configuration information of the reference terminal device is the same as the subband configuration information in the frequency domain configuration information to avoid the cross interference.

As another example showing that the frequency domain configuration information indicates the uplink frequency domain resources and/or the downlink frequency domain resources to be configured for the neighbor cell, after determining the uplink frequency domain resources and/or the downlink frequency domain resources of the target cell, the network device in the target cell may determine the uplink frequency domain resources and/or the downlink frequency domain resources to be configured for the neighbor cell according to the uplink frequency domain resources and/or the downlink frequency domain resources of the target cell to avoid the cross interference between the target cell and the neighbor cell. Therefore, the frequency domain configuration information may be generated based on the uplink frequency domain resources and/or the downlink frequency domain resources to be configured for the neighbor cell, and is sent to the neighbor cell network device. Accordingly, after receiving the frequency domain configuration information, the neighbor cell network device may configure the uplink frequency domain resources and/or the downlink frequency domain resources for the neighbor cell directly according to the frequency domain configuration information.

In a possible implementation of the example of the present disclosure, the network device in the target cell may communicate directly with the neighbor cell network device. For example, the network device in the target cell may send the frequency domain configuration information to the neighbor cell network device through an Xn interface.

In a possible implementation of the example of the present disclosure, the network device in the target cell may communicate indirectly with the neighbor cell network device. For example, the network device in the target cell may send the frequency domain configuration information to the neighbor cell network device via the target terminal device. That is, the network device in the target cell may send the frequency domain configuration information to the target terminal device. Accordingly, after receiving the frequency domain configuration information, the target terminal device may forward the frequency domain configuration information to the neighbor cell network device.

The target terminal device may be, for example, the terminal device located at the edges of the target cell and the neighbor cell. That is, the target terminal device may be located in the overlapping area between the target cell and the neighbor cell.

According to the resource configuration method in the example of the present disclosure, the network device in the target cell sends the frequency domain configuration information to the neighbor cell network device. The frequency domain configuration information indicates the uplink frequency domain resources and/or the downlink frequency domain resources of the target cell, or the frequency domain configuration information indicates the uplink frequency domain resources and/or the downlink frequency domain resources to be configured for the neighbor cell. Therefore, after receiving the frequency domain configuration information, the neighbor cell network device may configure the uplink frequency domain resources and/or the downlink frequency domain resources for the neighbor cell of the target cell according to the frequency domain configuration information to avoid the cross interference, thereby improving the transmission performance. That is, the cross interference between different cells is avoided by exchanging the frequency domain information between the network devices, which can not only improve the transmission performance, but also improve the flexibility and the adaptability of the method, thereby meeting actual application demand.

With reference to FIG. 4, it is a schematic flowchart of another resource configuration method provided in an example of the present disclosure. The resource configuration method may be performed by the network device in the communication system illustrated in FIG. 1. For example, it may be performed by the network device in a target cell. The target cell may be any serving cell.

The resource configuration method may be performed alone, or in combination with any example of the present disclosure or any possible implementation in the example, or in combination with any technical solution in related technologies.

As illustrated in FIG. 4, the resource configuration method may include, but is not limited to, the following step 401.

At step 401, frequency domain configuration information is sent to a neighbor cell network device, where the frequency domain configuration information includes frequency domain information on at least one subband of the target cell or a neighbor cell and transmission direction indication information on the at least one subband.

In the example of the present disclosure, the frequency domain configuration information may be based on a subband granularity. When the frequency domain configuration information indicates uplink frequency domain resources and/or downlink frequency domain resources of the target cell, the frequency domain configuration information may include the frequency domain information on the at least one subband of the target cell and the transmission direction indication information on the at least one subband of the target cell. When the frequency domain configuration information indicates uplink frequency domain resources and/or downlink frequency domain resources to be configured for the neighbor cell, the frequency domain configuration information may include the frequency domain information on the at least one subband of the neighbor cell and the transmission direction indication information on the at least one subband of the neighbor cell.

The transmission direction indication information on each subband may indicate a transmission direction of the corresponding subband. For example, it indicates the transmission direction of the corresponding subband is DL or UL.

The frequency domain information on each subband may include frequency domain information such as a bandwidth of the corresponding subband, frequency range information on a working carrier to which the corresponding subband belongs, and a number of subbands included in the working carrier to which the corresponding subband belongs.

In any example of the present disclosure, when indicating the uplink frequency domain resources and/or the downlink frequency domain resources of the target cell, the frequency domain configuration information may further include beam configuration information on at least one subband of the target cell. For example, the frequency domain configuration information may include beam direction information on the at least one subband of the target cell. When indicating the uplink frequency domain resources and/or the downlink frequency domain resources to be configured for the neighbor cell, the frequency domain configuration information may further include beam configuration information on the at least one subband of the neighbor cell. For example, the frequency domain configuration information may include beam direction information on the at least one subband of the neighbor cell.

The beam direction information on the at least one subband may also be referred to as the beam configuration information.

According to the resource configuration method in the examples of the present disclosure, the network device in the target cell sends the frequency domain configuration information to the neighbor cell network device. The frequency domain configuration information indicates the uplink frequency domain resources and/or the downlink frequency domain resources of the target cell, or the frequency domain configuration information indicates the uplink frequency domain resources and/or the downlink frequency domain resources to be configured for the neighbor cell. Therefore, after receiving the frequency domain configuration information, the neighbor cell network device may configure the uplink frequency domain resources and/or the downlink frequency domain resources for the neighbor cell of the target cell according to the frequency domain configuration information to avoid the cross interference, thereby improving the transmission performance. That is, the cross interference between different cells is avoided by exchanging the frequency domain information between the network devices, which can not only improve the transmission performance, but also improve the flexibility and the adaptability of the method, thereby meeting actual application demand.

It is to be noted that these possible implementations may be performed separately or in combination, which is not limited in the examples of the present disclosure.

With reference to FIG. 5, it is a schematic flowchart of another resource configuration method provided in an example of the present disclosure. The resource configuration method may be performed by the network device in the communication system illustrated in FIG. 1. For example, it may be performed by the network device in a target cell. The target cell may be any serving cell.

The resource configuration method may be performed alone, or in combination with any example of the present disclosure or any possible implementation in the example, or in combination with any technical solution in related technologies.

As illustrated in FIG. 5, the resource configuration method may include, but is not limited to, the following step 501.

At step 501, frequency domain configuration information is sent to a neighbor cell network device, where the frequency domain configuration information includes frequency domain information on at least one subband of the target cell or a neighbor cell and transmission direction indication information on the at least one subband, and the transmission direction indication information is configured as one of the following: indicating uplink only; indicating downlink only; indicating neither the uplink nor the downlink.

When indicating uplink frequency domain resources and/or downlink frequency domain resources of the target cell, the frequency domain configuration information may include the frequency domain information on the at least one subband of the target cell and the transmission direction indication information on the at least one subband of the target cell. When indicating uplink frequency domain resources and/or downlink frequency domain resources to be configured for the neighbor cell, the frequency domain configuration information may include the frequency domain information on the at least one subband of the neighbor cell and the transmission direction indication information on the at least one subband of the neighbor cell.

The transmission direction indication information on the at least one subband may also be referred to as uplink/downlink configuration information.

In the examples of the present disclosure, the explanation of the frequency domain information on the at least one subband may refer to the relevant description of any example of the present disclosure, which is not repeated here.

In the examples of the present disclosure, the transmission direction indication information on each subband may indicate that the corresponding subband is only used for the uplink, or indicate that the corresponding subband is only used for the downlink, or indicate that the corresponding subband is used neither for the uplink nor for the downlink.

As an example, each subband may have one piece of transmission direction indication information, which may be indicated by 2 bits. For example, as shown in Table 1, it indicates that the corresponding subband is used only for the UL when the status bits of the 2 bits are 00, indicates that the corresponding subband is used only for the DL when the status bits of the 2 bits are 01, and indicates that the corresponding subband is used for neither the UL nor the DL when the status bits of the 2 bits are 10.

TABLE 1

| Indication information | Transmission Direction |
|---|---|
| 00 | DL |
| 01 | UL |
| 10 | Flexible |
| 11 | Reserve |

The term “Flexible” indicates that the transmission direction of the corresponding subband is not configured, that is, it indicates that the corresponding subband is used neither for the uplink nor for the downlink. The transmission direction of the subband may be configured as required later. For example, the transmission direction of the subband is configured to be used only for the UL, or the transmission direction of the subband is configured to be used only for the DL. The term “Reserve” means that the corresponding status bits are reserved and do not represent valid status bits.

It is to be understood that each element and each corresponding relationship in Table 1 exist independently. These elements and these corresponding relationships are listed in the same table as examples. However, it does not mean that all the elements or all the corresponding relationships in the table have to exist at the same time as shown in Table 1. The value of each element and each corresponding relationship are independent of the value of any other element or any other corresponding relationship in Table 1. Therefore, those skilled in the art may understand that the value of each element and each corresponding relationship in Table 1 is an independent example.

It is to be noted that the example is only described by taking the status bits “00” to indicate that the transmission direction of the subband is “used only for UL”, taking the status bits “01” to indicate that the transmission direction of the subband is “used only for DL”, and taking the status bits “10” to indicate that the transmission direction of the subband is “used for neither UL nor DL”. However, the present disclosure is not limited by such the example. For example, it may take the status bits “00” to indicate that the transmission direction of the subband is “used for neither UL nor DL”, take the status bits “01” to indicate that the transmission direction of the subband is “used only for UL”, and take the status bits “10” to indicate that the transmission direction of the subband is “used only for DL”.

Alternatively, it may take 3 bits, 4 bits, 5 bits, etc. to indicate the transmission direction indication information. For example, it may take the status bits “001” to indicate that the transmission direction of the subband is “used only for UL”, take the status bits “010” to indicate that the transmission direction of the subband is “used only for DL”, and take the status bits “100” to indicate that the transmission direction of the subband is “used for neither UL nor DL”, etc., which is not limited by the present disclosure.

According to the resource configuration method in the examples of the present disclosure, the network device in the target cell sends the frequency domain configuration information to the neighbor cell network device. The frequency domain configuration information indicates the uplink frequency domain resources and/or the downlink frequency domain resources of the target cell, or the frequency domain configuration information indicates the uplink frequency domain resources and/or the downlink frequency domain resources to be configured for the neighbor cell. Therefore, after receiving the frequency domain configuration information, the neighbor cell network device may configure the uplink frequency domain resources and/or the downlink frequency domain resources for the neighbor cell of the target cell according to the frequency domain configuration information to avoid the cross interference, thereby improving the transmission performance. That is, the cross interference between different cells is avoided by exchanging the frequency domain information between the network devices, which can not only improve the transmission performance, but also improve the flexibility and the adaptability of the method, thereby meeting actual application demand.

It is to be noted that these possible implementations may be performed separately or in combination, which is not limited in the examples of the present disclosure.

With reference to FIG. 6, it is a schematic flowchart of another resource configuration method provided in an example of the present disclosure. The resource configuration method may be performed by the network device in the communication system illustrated in FIG. 1. For example, it may be performed by the network device in a target cell. The target cell may be any serving cell.

The resource configuration method may be performed alone, or in combination with any example of the present disclosure or any possible implementation in the example, or in combination with any technical solution in related technologies.

As illustrated in FIG. 6, the resource configuration method may include, but is not limited to, the following step 601.

At step 601, frequency domain configuration information is sent to a neighbor cell network device, where the frequency domain configuration information includes transmission direction indication information on at least one subband of the target cell or a neighbor cell and frequency domain information on the at least one subband, and the frequency domain information includes at least one of the following: frequency range information on a working carrier to which the at least one subband belongs, a bandwidth of each of the at least one subband, and a number of subbands included in the working carrier to which the at least one subband belongs.

The frequency domain information on the at least one subband may also be referred to as subband configuration information.

When indicating uplink frequency domain resources and/or downlink frequency domain resources of the target cell, the frequency domain configuration information may include transmission direction indication information on the at least one subband of the target cell and the frequency domain information on the at least one subband of the target cell. When indicating uplink frequency domain resources and/or downlink frequency domain resources to be configured for the neighbor cell, the frequency domain configuration information may include transmission direction indication information on the at least one subband of the neighbor cell and the frequency domain information on the at least one subband of the neighbor cell.

In the examples of the present disclosure, the transmission direction indication information on the at least one subband may refer to the relevant description in any example of the present disclosure, which is not repeated here.

In the examples of the present disclosure, the frequency domain information on each subband may include at least one of the frequency range information on the working carrier to which the corresponding subband belongs, the bandwidth of the corresponding subband, or the number of the subbands included in the working carrier to which the corresponding subband belongs.

In a possible implementation of the examples of the present disclosure, the frequency range information on the working carrier may include a lowest frequency and a highest frequency of the working carrier.

In a possible implementation of the examples of the present disclosure, the frequency range information on the working carrier may include the lowest frequency of the working carrier and a bandwidth occupied by the working carrier.

In a possible implementation of the examples of the present disclosure, the frequency range information on the working carrier may include the lowest frequency of the working carrier and the highest frequency of the working carrier, as well as include the lowest frequency of the working carrier and the bandwidth occupied by the working carrier.

According to the resource configuration method in the examples of the present disclosure, the network device in the target cell sends the frequency domain configuration information to the neighbor cell network device. The frequency domain configuration information indicates the uplink frequency domain resources and/or the downlink frequency domain resources of the target cell, or the frequency domain configuration information indicates the uplink frequency domain resources and/or the downlink frequency domain resources to be configured for the neighbor cell. Therefore, after receiving the frequency domain configuration information, the neighbor cell network device may configure the uplink frequency domain resources and/or the downlink frequency domain resources for the neighbor cell of the target cell according to the frequency domain configuration information to avoid the cross interference, thereby improving the transmission performance. That is, the cross interference between different cells is avoided by exchanging the frequency domain information between the network devices, which can not only improve the transmission performance, but also improve an adaptability of the method, thereby meeting actual application demand.

It is to be noted that these possible implementations may be performed individually or in combination, which is not limited in the examples of the present disclosure.

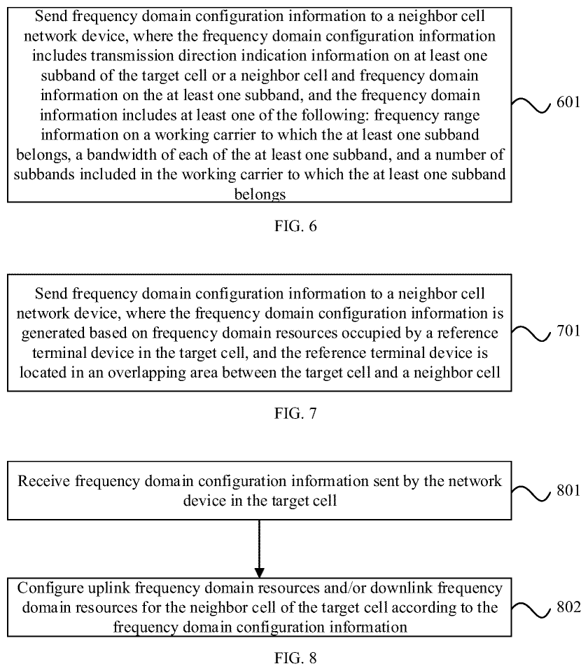

With reference to FIG. 7, it is a schematic flowchart of another resource configuration method provided in an example of the present disclosure. The resource configuration method may be performed by the network device in the communication system illustrated in FIG. 1. For example, it may be performed by the network device in a target cell. The target cell may be any serving cell.

The resource configuration method may be performed alone, or in combination with any example of the present disclosure or any possible implementation in the example, or in combination with any technical solution in related technologies.

As illustrated in FIG. 7, the resource configuration method may include, but is not limited to, the following step 701.

At step 701, frequency domain configuration information is sent to a neighbor cell network device, where the frequency domain configuration information is generated based on frequency domain resources occupied by a reference terminal device in the target cell, and the reference terminal device is located in an overlapping area between the target cell and a neighbor cell.

The frequency domain configuration information indicates uplink frequency domain resources and/or downlink frequency domain resources of the target cell, or indicates uplink frequency domain resources and/or downlink frequency domain resources to be configured for the neighbor cell.

In the examples of the present disclosure, the explanation of the frequency domain configuration information may refer to the relevant description in any example of the present disclosure, which is not repeated here.

It is to be noted that the number of the neighbor cells of the target cell may be at least one, and accordingly, the number of the neighbor cell network devices may be at least one. That is, the number of the neighbor cell network devices may be one or more than one, which is not limited in the present disclosure.

For example, assuming that the target cell is Cell A and the neighbor cells of the target cell are Cell B, Cell C, and Cell D, the neighbor cell network devices may be the network device in Cell B, the network device in Cell C, and the network device in Cell D.

In the examples of the present disclosure, when the number of the neighbor cell network devices is at least one, the frequency domain configuration information sent by the network device in the target cell to various neighbor cell network devices may be identical or different, which is not limited in the present disclosure. Still taking the above example, the frequency domain configuration information sent by the network device in Cell A to the network device in Cell B may be identical with or different from the frequency domain configuration information sent to the network device in Cell C and the frequency domain configuration information sent to the network device in Cell D.

It may be understood that in the case where the target cell has multiple neighbor cells, when terminal devices located in overlapping areas between different neighbor cells and the target cell occupy different frequency domain resources of the target cell, the interferences on the network devices in various neighbor cell (i.e., various neighbor cell network devices) may be different. As an example, still taking the above example, the frequency domain resources of the target cell occupied by the terminal device located in the overlapping area between Cell A and Cell B may interfere with the network device in Cell B rather than the network device in Cell C. As another example, the frequency domain resources of the target cell occupied by the terminal device located in the overlapping area between Cell A and Cell C may interfere with the network device in Cell C rather than the network devices in both Cell B and Cell D.

Therefore, in the example of the present disclosure, for each neighbor cell of the target cell, the network device of the target cell may generate the frequency domain configuration information based on the frequency domain resources of the target cell occupied by the terminal device (denoted as the reference terminal device in the present disclosure) located in the overlapping area between the neighbor cell and the target cell, and send the frequency domain configuration information to the network device in the neighbor cell.

That is, since the frequency domain resources of the target cell occupied by the terminal devices located in the overlapping areas with different cells may be different, the frequency domain configuration information sent to the network devices in various neighbor cells may be different.

According to the resource configuration method in the examples of the present disclosure, the network device in the target cell sends the frequency domain configuration information to the neighbor cell network device. The frequency domain configuration information indicates the uplink frequency domain resources and/or the downlink frequency domain resources of the target cell, or the frequency domain configuration information indicates the uplink frequency domain resources and/or the downlink frequency domain resources to be configured for the neighbor cell. Therefore, after receiving the frequency domain configuration information, the neighbor cell network device may configure the uplink frequency domain resources and/or the downlink frequency domain resources for the neighbor cell of the target cell according to the frequency domain configuration information to avoid the cross interference, thereby improving the transmission performance. That is, the cross interference between different cells is avoided by exchanging the frequency domain information between the network devices, which can not only improve the transmission performance, but also improve the flexibility and the adaptability of the method, thereby meeting actual application demand.

It is to be noted that these possible implementations may be performed individually or in combination, which is not limited in the example of the present disclosure.

With reference to FIG. 8, it is a schematic flowchart of another resource configuration method provided in an example of the present disclosure. The resource configuration method may be performed by the network device in the communication system illustrated in FIG. 1. For example, it may be performed by the network device in a neighbor cell of a target cell (i.e., a neighbor cell network device).

The resource configuration method may be performed alone, or in combination with any example of the present disclosure or one or more possible implementations in the example, or in combination with any technical solution in related technologies.

As illustrated in FIG. 8, the resource configuration method may include, but is not limited to, the following steps 801 and 802.

At step 801, frequency domain configuration information sent by the network device in the target cell is received.

In the examples of the present disclosure, the neighbor cell network device may receive the frequency domain configuration information sent by the network device in the target cell.

As an example, the neighbor cell network device may communicate directly with the network device in the target cell, and thus the neighbor cell network device may directly receive the frequency domain configuration information sent by the network device in the target cell.

As another example, the neighbor cell network device may communicate indirectly with the network device in the target cell. For example, the neighbor cell network device may receive the frequency domain configuration information forwarded by a target terminal device. That is, the network device in the target cell may send the frequency domain configuration information to the neighbor cell network device via the target terminal device.

It is to be noted that the explanation of the resource configuration method performed by the network device in the target cell in any of the foregoing examples is also applicable to the resource configuration method performed by the neighbor cell network device with similar implementation principles, which is not repeated here.

In a possible implementation of the examples of the present disclosure, the frequency domain configuration information may include frequency domain information on at least one subband occupied by the target cell and transmission direction indication information on the at least one subband.

In a possible implementation of the examples of the present disclosure, the frequency domain configuration information may include frequency domain information on at least one subband of the neighbor cell and transmission direction indication information on the at least one subband.

In a possible implementation of the examples of the present disclosure, the transmission direction indication information is configured as one of the following: indicating uplink only; indicating downlink only; and indicating neither uplink nor downlink.

In a possible implementation of the examples of the present disclosure, the frequency domain information includes at least one of the following: frequency range information on a working carrier to which the at least one subband belongs; a bandwidth of each of the at least one subband; or a number of subbands included in the working carrier to which the at least one subband belongs.

In a possible implementation of the examples of the present disclosure, the frequency range information includes at least one of the following: a lowest frequency of the working carrier and a highest frequency of the working carrier; or the lowest frequency of the working carrier and a bandwidth occupied by the working carrier.

In a possible implementation of the examples of the present disclosure, the frequency domain configuration information further includes: beam direction information on the at least one sub-band.

In a possible implementation of the examples of the present disclosure, the frequency domain configuration information is generated based on frequency domain resources occupied by a reference terminal device in the target cell. The reference terminal device is located in an overlapping area between the target cell and the neighbor cell.

At step 802, uplink frequency domain resources and/or downlink frequency domain resources are configured for the neighbor cell of the target cell according to the frequency domain configuration information.

In the examples of the present disclosure, after receiving the frequency domain configuration information from the target cell, the neighbor cell network device may configure the uplink frequency domain resources and/or the downlink frequency domain resources for the neighbor cell of the target cell according to the frequency domain configuration information from the target cell.

As an example showing that the frequency domain configuration information indicates the uplink frequency domain resources and/or the downlink frequency domain resources of the target cell, after determining the uplink frequency domain resources and/or the downlink frequency domain resources of the target cell, the network device in the target cell may generate the frequency domain configuration information based on the uplink frequency domain resources and/or the downlink frequency domain resources of the target cell, and send the frequency domain configuration information to the neighbor cell network device. Accordingly, after receiving the frequency domain configuration information, the neighbor cell network device may determine a reference terminal device (or called a target terminal device) in the neighbor cell (i.e., the cell corresponding to the neighbor cell network device). The reference terminal device (or the target terminal device) is a terminal device located at the edge of both the neighbor cell and the target cell. That is, the reference terminal device may be located in an overlapping area between the target cell and the neighbor cell. Thus, the neighbor cell network device may configure the frequency domain resources of the neighbor cell used by the reference terminal device according to the received frequency domain configuration information. For example, according to the received frequency domain configuration information, it may configure subband configuration information (e.g., frequency range information of a working carrier to which the subband belongs, a bandwidth of the subband, a number of subbands included in the working carrier to which the subband belongs, etc.) for the reference terminal device. The subband configuration information on the reference terminal device is identical with the subband configuration information in the frequency domain configuration information to avoid the cross interference.

That is, after receiving the frequency domain configuration information sent by the network device in the target cell, the neighbor cell network device may determine subband configuration information on the reference terminal device located in the area of its own cell adjacent to the target cell according to the frequency domain configuration information. For example, the reference terminal device may be configured with the same subband configuration as in the frequency domain configuration information to avoid the cross interference.

As another example showing that the frequency domain configuration information indicates the uplink frequency domain resources and/or the downlink frequency domain resources to be configured for the neighbor cell, after determining the uplink frequency domain resources and/or the downlink frequency domain resources of the target cell, the network device in the target cell may determine the uplink frequency domain resources and/or the downlink frequency domain resources to be configured for the neighbor cell based on the uplink frequency domain resources and/or the downlink frequency domain resources of the target cell to avoid the cross interference between the target cell and the neighbor cell. Therefore, the frequency domain configuration information is generated based on the uplink frequency domain resources and/or the downlink frequency domain resources to be configured for the neighbor cell, and is sent to the neighbor cell network device. Accordingly, after receiving the frequency domain configuration information, the neighbor cell network device may configure the uplink frequency domain resources and/or the downlink frequency domain resources for the neighbor cell directly according to the frequency domain configuration information.

According to the resource configuration method of the examples of the present disclosure, the neighbor cell network device receives the frequency domain configuration information sent by the network device in the target cell, and configures the uplink frequency domain resources and/or the downlink frequency domain resources for the neighbor cell of the target cell according to the frequency domain configuration information. Therefore, the neighbor cell network device configures the uplink frequency domain resources and/or the downlink frequency domain resources for the neighbor cell according to the frequency domain configuration information sent by the network device in the target cell, which can avoid the cross interference, thereby improving the transmission performance. That is, the cross interference between different cells is avoided by exchanging the frequency domain information between the network devices, which can not only improve the transmission performance, but also improve the flexibility and the adaptability of the method, thereby meeting actual application demand.

It is to be noted that these possible implementations may be performed separately or in combination, which is not limited in the examples of the present disclosure.

In the examples provided by the present disclosure, the methods provided by the examples of the present disclosure are introduced from the perspectives of the network device in the target cell and the neighbor cell network device. In order to achieve the various functions in the methods provided in the foregoing examples of the present disclosure, the network device in the target cell and the neighbor cell network device may include hardware structures and software modules, and implement the various functions in the form of the hardware structures, the software modules, or the hardware structures plus the software modules. A certain function among the various functions may be implemented in the form of a hardware structure, a software module, or a hardware structure plus a software module.

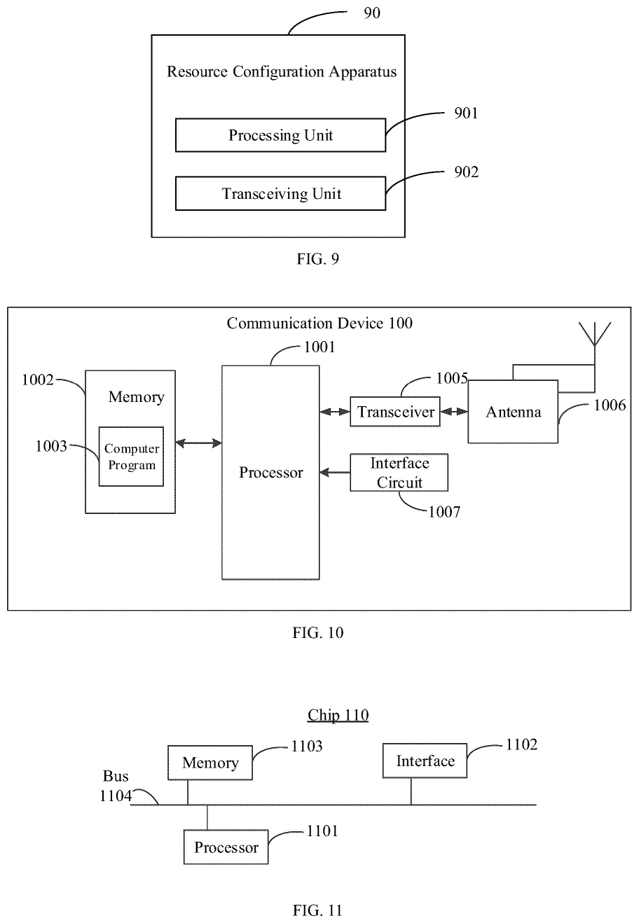

With reference to FIG. 9, it is a schematic structural diagram of a resource configuration apparatus 90 provided in an example of the present disclosure. The resource configuration apparatus 90 illustrated in FIG. 9 may include a processing unit 901 and a transceiving unit 902. The transceiving unit 902 may include a transmitting unit and/or a receiving unit (neither shown). The transmitting unit is configured to implement a transmission function, and the receiving unit is configured to implement a reception function. The transceiving unit may implement the transmission function and/or the reception function. The transceiving unit 902 may be any known hardware capable of sending and receiving information, such as an input/output (I/O) device. The processing unit 901 may be any known hardware capable of processing information and controlling an apparatus, such as processor.

The resource configuration apparatus 90 may be a network device (such as a network device in a target cell or a neighbor cell network device), or an apparatus in the network device, or an apparatus that is capable of being matched with and used in conjunction with the network device.

When the resource configuration apparatus 90 is the network device in the target cell: the transceiving unit 902 is configured to send frequency domain configuration information to a network device in a neighbor cell of the target cell. The frequency domain configuration information indicates uplink frequency domain resources and/or downlink frequency domain resources of the target cell. Alternatively, the frequency domain configuration information indicates uplink frequency domain resources and/or downlink frequency domain resources to be configured for the neighbor cell.

In some examples, when the frequency domain configuration information indicates the uplink frequency domain resources and/or the downlink frequency domain resources of the target cell, the frequency domain configuration information may include: frequency domain information on at least one subband of the target cell, and transmission direction indication information on the at least one subband of the target cell.

In some examples, when the frequency domain configuration information indicates the uplink frequency domain resources and/or the downlink frequency domain resources to be configured for the neighbor cell, the frequency domain configuration information may include: frequency domain information on at least one subband of the neighbor cell, and transmission direction indication information on the at least one subband of the neighbor cell.

In some examples, the transmission direction indication information is configured as one of the following: indicating uplink only, indicating downlink only, and indicating neither the uplink nor the downlink.

In some examples, the frequency domain information includes at least one of the following: frequency range information on a working carrier to which the at least one subband belongs, a bandwidth of each of the at least one subband, or a number of subbands included in the working carrier to which the at least one subband belongs.

In some examples, the frequency range information includes at least one of the following: a lowest frequency of the working carrier and a highest frequency of the working carrier, or a lowest frequency of the working carrier and a bandwidth occupied by the working carrier.

In some examples, the frequency domain configuration information further includes: beam direction information on the at least one subband occupied by the target cell.

In some examples, the frequency domain configuration information further includes: beam direction information on the at least one subband to be configured for the neighbor cell.

In some examples, the frequency domain configuration information is generated based on frequency domain resources occupied by a reference terminal device in the target cell. The reference terminal device is located in an overlapping area between the target cell and the neighbor cell.

When the resource configuration apparatus 90 is the neighbor cell network device:
the transceiving unit 902 is configured to receive frequency domain configuration information sent by the network device in the target cell.

The processing unit 901 is configured to configure uplink frequency domain resources and/or downlink frequency domain resources for the neighbor cell according to the frequency domain configuration information.

In some examples, the frequency domain configuration information includes: frequency domain information on at least one subband of the target cell, and transmission direction indication information on the at least one subband of the target cell.

In some examples, the frequency domain configuration information includes: frequency domain information on at least one subband of the neighbor cell, and transmission direction indication information on the at least one subband of the neighbor cell.

In some examples, the transmission direction indication information is configured as one of the following: indicating uplink only, indicating downlink only, and indicating neither the uplink nor the downlink.

In some examples, the frequency domain information includes at least one of the following: frequency range information on a working carrier to which the at least one subband belongs, a bandwidth of each of the at least one subband, or a number of subbands included in the working carrier to which the at least one subband belongs.

In some examples, the frequency range information includes at least one of the following: a lowest frequency of the working carrier and a highest frequency of the working carrier, or a lowest frequency of the working carrier and a bandwidth occupied by the working carrier.

In some examples, the frequency domain configuration information further includes: beam direction information on the at least one subband occupied by the target cell.

In some examples, the frequency domain configuration information is generated based on frequency domain resources occupied by a reference terminal device in the target cell. The reference terminal device is located in an overlapping area between the target cell and the neighbor cell.

It is to be noted that the explanation of the method performed on the network device side in the target cell in any of the examples of FIG. 3 to FIG. 7, or the explanation of the method performed on the neighbor cell network device side in the example of FIG. 8, is also applicable to the resource configuration apparatus 90 of this example with similar implementation principles, which is not repeated here.

With reference to FIG. 10, it is a schematic structural diagram of a communication device according to an example of the present disclosure. The communication device 100 may be a network device, or may be a chip, a chip system, or a processor that supports the network device to implement the methods. The device may be configured to implement the methods described in the method examples, whose details may refer to the descriptions in the method examples.

The communications device 100 may include one or more processors 1001. The processor 1001 may be a general processor or a dedicated processor or the like. For example, it may be a baseband processor or a central processing unit. The baseband processor may be configured to process communication protocols and communication data, and the central processor may be configured to control a communication device (such as a base station, a baseband chip, a terminal device, a terminal device chip, a distributed unit (DU) or a centralized unit (CU), etc.) to execute a computer program and process data of the computer program.

Alternatively, or additionally, the communication device 100 may further include one or more memories 1002, on which a computer program 1003 may be stored, and the one or more processors 1001 execute the computer program 1003, so as to enable the communication device 100 to perform the methods described in the foregoing method examples. The computer program 1003 may be solidified in the one or more processors 1001. In this case, the one or more processors 1001 may be implemented by hardware.

Alternatively, or additionally, the one or more memories 1002 may further store data. The communication device 100 and the one or more memories 1002 may be set separately or integrated together.

Alternatively, or additionally, the communication device 100 may further include one or more transceivers 1005 and one or more antennas 1006. The transceiver 1005 may be referred to as a transceiving unit, a transceiving machine, a transceiving circuit, or an input/output (I/O) device, etc., and is configured to implement a transmission and reception function. The transceiver 1005 may include a receiver and a transmitter. The receiver may be called a receiving machine or a receiving circuit for implementing a reception function, and the transmitter may be called a transmitting machine or a transmitting circuit for implementing a transmission function.

Alternatively, or additionally, the communication device 100 may further include one or more interface circuits 1007. The interface circuit 1007 is configured to receive and transmit code instructions to the one or more processors 1001. The one or more processors 1001 execute the code instructions to enable the communication device 100 to perform the methods described in the method examples.

When the communication device 100 is the terminal device, the one or more processors 1001 are configured to perform any method in the examples of FIG. 3 to FIG. 7 of the present disclosure.

When the communication device 100 is the network device, the one or more processors 1001 are configured to perform the method in the example illustrated in FIG. 8 of the present disclosure.

It is to be noted that the explanation of the resource configuration method in any one of the examples of FIG. 3 to FIG. 8 is also applicable to the communication device 100 of this example with similar implementation principles, which is not repeated here.

In an implementation, the one or more processors 1001 may include the transceiver for implementing the transmission and reception function. For example, the transceiver may be a transceiving circuit, or a transceiving interface, or a transceiving interface circuit. The transceiving circuit, interface or interface circuit for implementing the transmission and reception function may be separated or integrated together. The described one or more transceiving circuits, interfaces or interface circuits may be configured to read and write codes/data. Alternatively, the described one or more transceiving circuits, interfaces or interface circuits may be configured to transmit or transfer signals.

In an implementation, the communication device 100 may include one or more circuits, and the one or more circuits may implement the function of transmitting, receiving or communicating in the foregoing method examples. The one or more processors and the one or more transceivers described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The one or more processors and the one or more transceivers may also be fabricated with various IC processing technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above examples may be the network device in the target cell or the neighbor cell network device. However, the communication device described in the present disclosure is not limited by such a range, and the structure of the communication device may not be limited to FIG. 10. The communication device may be a stand-alone device or may be a part of a larger device. For example, the communication device may be: (1) a stand-alone IC, chip, or chip system or subsystem; (2) a set of one or more ICs, which may alternatively or additionally include storage components for storing data and computer programs; (3) ASIC, such as a modem; (4) modules that may be embedded in other devices; (5) a receiver, a terminal device, an intelligent terminal device, a cellular phone, a wireless device, a handset, a mobile unit, a vehicle device, a network device, a cloud device, an artificial intelligence device, etc.; and (6) others and so on.

For the case where the communications device may it may refer to the schematic structural diagram of a chip 110 illustrated in FIG. 11. The chip 110 illustrated in FIG. 11 includes one or more processors 1101, one or more interfaces 1102, one or more memories 1103, and a bus 1104. The number of the one or more processors 1101 may be one or more than one, the number of the one or more interfaces 1102 may be more than one, and the number of the one or more memories 1103 may be more than one. The processor(s) 1101, interface(s) 1102, and the memory(s) 1103 are connected via bus 1104.

For the case where the chip 110 is configured to implement the functions of the network device in the target cell in the examples of the present disclosure: the interface 1102 is configured for code instructions and transmission to the processor 1101. The processor 1101 is configured to execute code instructions to perform the methods illustrated in any one of the examples of FIG. 3 to FIG. 7.

For the case where the chip 110 is configured to implement the functions of the network device in the neighbor cell in the examples of the present disclosure: the interface 1102 is configured for code instructions and transmission to the processor 1101. The processor 1101 is configured to run code instructions to perform the method illustrated in any one of the examples of FIG. 8.

Alternatively, and additionally, the chip 110 also includes one or more memories 1103 for storing necessary computer programs and data.

It is to be noted that the explanation of the resource configuration methods in any one of the examples of FIG. 3 to FIG. 8 is also applicable to the chip 110 of this example with similar implementation principles, which are not repeated here.

Those skilled in the art may also understand that various illustrative logical blocks and steps presented in the examples of the present disclosure may be implemented through electronic hardware, computer software, or a combination of the both. Whether such functions are implemented through the hardware or the software depends on specific applications and overall system design requirements. Those skilled in the art may use various approaches to implement the described function for each specific application. However, such implementation should not be understood as exceeding the protection scope of the examples of the present disclosure.

An example of the present disclosure further provides a communication system, which includes the resource configuration device as the network device in the example of FIG. 10, or the system includes the communication device as the network device in the example of FIG. 11.

The present disclosure also provides a non-transitory computer-readable storage medium on which instructions are stored. The instructions, when executed by a computer, implement the functions of any one of the method examples.

The present disclosure also provides a computer program product, which implements the functions of any one of the method examples when being executed by a computer.

In the described examples, it can be implemented in whole or in part by software, hardware, firmware, or any combination thereof. When implemented in software, it may be implemented in whole or in part in the form of a computer program product. The computer program product includes one or more computer programs. When the computer programs are loaded and executed on a computer, the processes or function according to the examples of the present disclosure are generated in whole or in part. The computer may be a general-purpose computer, a dedicated computer, a computer network, or another programmable device. The computer programs may be stored in a computer-readable storage medium or transmitted from one computer-readable storage medium to another computer-readable storage medium, for example, the computer programs may be transmitted from a website site, a computer, a server or a data center via wire (for example, coaxial cable, optical fiber, digital subscriber line (DSL)) or wireless (for example, infrared, wireless, microwave, etc.) to another website, another computer, another server, or another data center. The computer-readable storage medium may be any available medium that can be accessed by a computer or a data storage device such as a server and a data center integrating one or more available media. The available medium may be a magnetic medium (for example, a floppy disk, a hard disk, and a magnetic tape), an optical medium (for example, a high-density digital video disc (DVD)), or a semiconductor medium (for example, a solid state disk (SSD)), etc.

Those of ordinary skill in the art may understand that the first, second, and other numbers involved in the present disclosure are only for convenience of description, instead of limiting the scope of the examples of the present disclosure or indicating a sequential order.

“At least one” in the present disclosure may also be described as “one or more than one”. The “more than more” may refer to two, three, four or more, which is not limited by the present disclosure. In the examples of the present disclosure, for a technical feature, the technical features are distinguished by “first,” “second,” “third,” “A,” “B,” “C,” and “D,” etc. There is no any sequential order or size order between the technical features described by the “first,” “second,” “third,” “A,” “B,” “C” and “D.”

It can be further understood that the term “a plurality of” in the present disclosure refers to two or more than two, and other quantifiers are similar. The term “and/or” describes the association relationships between associated objects, indicating that there may be three types of relationships. For example, A and/or B means that A exists alone, A and B exist at the same time, and B exists alone. The character “/” generally indicates that the associated objects before and after are in an “or” relationship. The singular forms “a”, “said” and “the” are also intended to include its plural form, unless clearly indicated otherwise in the context.

The word “if” as used here may be interpreted as “when”, “upon”, or “in response to determining”.

The corresponding relationships shown in each table in the present disclosure may be configured or predefined. The values of the information in each table are only examples and may be configured to other values, which is not limited in the present disclosure. When configuring the corresponding relationships between information and parameters, it is not necessarily required to configure all the corresponding relationship shown in each table. As an example, in the table of the present disclosure, the corresponding relationships shown in some rows may not be configured. As another example, appropriate deformation adjustments may be made based on the table, such as splitting, merging, etc. The name of the parameter shown in the title of each table may also be presented under other names understandable to the communication device, and the values or representations of its parameters may also be presented under other values or representations understandable to the communication device. When implementing the various tables, other data structures may also be used, such as arrays, queues, containers, stacks, linear lists, pointers, linked lists, trees, graphs, structures, classes, heaps, or hash tables.

Being predefined in the present disclosure may be understood as being defined, being predefined, being stored, being pre-stored, being pre-negotiated, being pre-configured, being solidified, or being pre-burned.

Those skilled in the art may appreciate that the units and algorithm steps of each example described in conjunction with the example disclosed herein may be implemented by electronic hardware, computer software, or a combination of computer software and electronic hardware. Whether a certain function is performed in a hardware or software way depends on a specific application and design constraint conditions of the technical solution. Those skilled in the art may adopt a different method for each specific application to implement the described functions, which, however, should not be considered as being beyond the scope of the present disclosure.

Those skilled in the art may clearly understand that, for the convenience and brevity of description, the specific working processes of the systems, apparatuses and units described above may refer to the corresponding processes in the method examples and will not be repeated here.

The description is merely a specific embodiment of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

1. A resource configuration method, performed by a network device in a target cell, and the resource configuration method comprising:
sending frequency domain configuration information to a second network device in a neighbor cell of the target cell,
wherein the frequency domain configuration information indicates
at least one of first uplink frequency domain resources or first downlink frequency domain resources of the target cell, or
at least one of second uplink frequency domain resources or second downlink frequency domain resources to be configured for the neighbor cell.

2. The method according to claim 1,
wherein the frequency domain configuration information indicates at least one of the first uplink frequency domain resources or the first downlink frequency domain resources of the target cell, and the frequency domain configuration information comprises:
frequency domain information on at least one first subband of the target cell; and
transmission direction indication information on the at least one first subband; or
wherein the frequency domain configuration information indicates at least one of the second uplink frequency domain resources or the second downlink frequency domain resources to be configured for the neighbor cell, and the frequency domain configuration information comprises:
frequency domain information on at least one second subband of the neighbor cell; and
transmission direction indication information on the at least one second subband.

3. (canceled)

4. The method according to claim 2, wherein the transmission direction indication information is configured as one of the following:
indicating uplink only;
indicating downlink only; or
indicating neither the uplink nor the downlink.

5. The method according to claim 2, wherein the frequency domain information comprises at least one of the following:
frequency range information on a working carrier to which the at least one first subband or the at least one second subband belongs;
a bandwidth of each of the at least one first subband or the at least one second subband; or
a number of subbands comprised in the working carrier to which the at least one first subband or the at least one second subband belongs.

6. The method according to claim 5, wherein the frequency range information comprises at least one of the following:
a lowest frequency of the working carrier and a highest frequency of the working carrier; or
the lowest frequency of the working carrier and a bandwidth occupied by the working carrier.

7. The method according to claim 2,
wherein the frequency domain configuration information indicates at least one of the first uplink frequency domain resources or the first downlink frequency domain resources of the target cell, and the frequency domain configuration information further comprises:
beam direction information on the at least one first subband occupied by the target cell; or
wherein the frequency domain configuration information indicates at least one of the second uplink frequency domain resources or the second downlink frequency domain resources to be configured for the neighbor cell, and the frequency domain configuration information further comprises:
beam direction information on the at least one second subband to be configured for the neighbor cell.

8. (canceled)

9. The method according to claim 1, wherein the frequency domain configuration information is generated based on frequency domain resources occupied by a reference terminal device in the target cell, wherein the reference terminal device is located in an overlapping area between the target cell and the neighbor cell.

10. A resource configuration method, performed by a network device in a neighbor cell of a target cell, and the resource configuration method comprising:
receiving frequency domain configuration information sent by a second network device in the target cell; and
configuring at least one of uplink frequency domain resources or downlink frequency domain resources for the neighbor cell according to the frequency domain configuration information.

11. The method according to claim 10,
wherein the frequency domain configuration information comprises:
frequency domain information on at least one first subband occupied by the target cell; and
transmission direction indication information on the at least one first subband; or
wherein the frequency domain configuration information comprises:
frequency domain information on at least one second subband of the neighbor cell; and
transmission direction indication information on the at least one second subband.

12. (canceled)

13. The method according to claim 11, wherein the transmission direction indication information is configured as one of the following:
indicating uplink only;
indicating downlink only; or
indicating neither the uplink nor the downlink.

14. The method according to claim 11, wherein the frequency domain information comprises at least one of the following:
frequency range information on a working carrier to which the at least one first subband or the at least one second subband belongs;
a bandwidth of each of the at least one first subband or the at least one second subband; or
a number of subbands comprised in the working carrier to which the at least one first subband or the at least one second subband belongs.

15. The method according to claim 14, wherein the frequency range information comprises at least one of the following:
a lowest frequency of the working carrier and a highest frequency of the working carrier; or
the lowest frequency of the working carrier and a bandwidth occupied by the working carrier.

16. The method according to claim 11, wherein the frequency domain configuration information further comprises:
beam direction information of the at least one first subband or the at least one second subband.

17. The method according to claim 10,
wherein the frequency domain configuration information is generated based on frequency domain resources occupied by a reference terminal device in the target cell, and
wherein the reference terminal device is located in an overlapping area between the target cell and the neighbor cell.

18.-19. (canceled)

20. A communication device, comprising one or more processors and one or more memories,
wherein the one or more memories store a computer program, and
wherein the one or more processors execute the computer program stored in the one or more memories, causing the one or more processors to:
send frequency domain configuration information to a network device in a neighbor cell of a target cell,
wherein the frequency domain configuration information indicates
at least one of first uplink frequency domain resources or first downlink frequency domain resources of the target cell, or
at least one of second uplink frequency domain resources or second downlink frequency domain resources to be configured for the neighbor cell.

21. A communication device, comprising one or more processors and one or more memories,
wherein the one or more memories store a computer program, and
wherein the one or more processors execute the computer program stored in the one or more memories, causing the one or more processors to perform the method according to claim 10.

22.-23. (canceled)

24. A non-transitory computer-readable storage medium, configured to store instructions, wherein the instructions, when executed by a processor, cause the processor to implement the method according to claim 1.

25. A non-transitory computer-readable storage medium, configured to store instructions, wherein the instructions, when executed by a processor, cause the processor to implement the method according to claim 10.

26. A communication system, comprising the communication device according to claim 20.

27. The communication system according to claim 26, further comprising a second communication device, which comprises:
one or more processors and one or more memories,
wherein the one or more memories store a computer program, and
wherein the one or more processors execute the computer program stored in the one or more memories, causing the one or more processors to:
receive the frequency domain configuration information sent by the network device in the target cell; and
configure at least one of uplink frequency domain resources or downlink frequency domain resources for the neighbor cell according to the frequency domain configuration information.
